(19) United States
(12) Patent Application Publication
(10) Pub. No.: US 2012/0167908 A1
(43) Pub. Date: Jul. 5, 2012

(54) COMB AND METHOD FOR CLEANING THEREOF

(76) Inventor: Aharon Krishevski, Beit Shemesh (IL)

(21) Appl. No.: 13/395,889

(22) PCT Filed: Sep. 13, 2010
(86) PCT No.: PCT/IL10/00748

§ 371 Date: Mar. 14, 2012

(30) Foreign Application Priority Data
Sep. 16, 2009 (US) 61242814

(51) Int. Cl. A45D 24/42; B08B 1/00

(52) U.S. Cl. 132/119; 134/6

(57) ABSTRACT

In one aspect, the present invention is directed to a comb (2) comprising teeth (4) extending from the body (8) of said comb, said comb comprising: a teeth cleaner (14) comprising a perforated bar (6) in which the holes (20) thereof surround said teeth (4), wherein said perforated-bar (6) and said teeth (4) are movable one along and in relation to the other, thereby allowing removing stuck objects from said teeth (4).

The current application claims the benefit of U.S. Provisional Patent Application No. 61/242,814, entitled “A CLEANING APPARATUS FOR A COMB FOR HAIR AND LICE”, filed 16 Sep. 2009, incorporated herein by reference.

### FIELD OF THE INVENTION

The present invention relates to the field of combs. More particularly, the invention relates to a method and apparatus for cleaning a comb and a lice comb.

### BACKGROUND OF THE INVENTION

A comb includes a body and teeth extending therefrom. The teeth of a lice comb are dense, for picking out lice, eggs, and other undesirable matter.

The comb, particularly when used for picking lice, must be cleaned after use. This is performed by hand, paper, flowing water or other means.

Since all these means are external to the comb, and unaesthetic, lice combing is a non-preferable activity.

All the methods described above have not yet provided satisfactory solutions to the problem of cleaning combs and especially lice combs.

It is an object of the present invention to provide a method and apparatus for cleaning combs and lice combs.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a comb (2) comprising teeth (4) extending from the body (8) of said comb, said comb comprising: a tooth cleaner (14) comprising a perforated-bar (6) in which the holes (20) thereof surrounding said teeth (4), wherein said perforated-bar (6) and said teeth (4) are movable one along and in relation to the other, thereby allowing removing stuck objects from said teeth (4).

The comb (2) may further comprise a springy element (18) for normally locating the perforated bar (6) near the comb-body (8), thereby by default allowing combing, and thereby the drawing of perforated bar (6) against the springy element (18) may clean the teeth (4).

The comb (2) may further comprise a lock (12), for locking the perforated bar (6) to attach the comb-body (8) to allow combing, and for unlocking the perforated bar (6), to allow the cleaning of teeth (4).

The comb (2) may further comprise a limiting element (24) for limiting the motion of the perforated bar (6) along the teeth (4), thereby the perforated bar (6) is limited to be held by the teeth (4).

The holes (20) of the perforated bar (6) may be elongated (length L), for substantially reaching the top (42) of the teeth (4) and yet being held thereby, thereby the perforated bar (6) can clean the edges (42) of the teeth (4).

The tooth cleaner (14) may be detachable.

In another aspect, the present invention is directed to a method for cleaning a comb (2), and a method for cleaning the teeth of a comb, the method comprising the steps of:
providing a perforated bar in which the holes thereof surround the teeth of said comb; and
drawing said perforated bar along said teeth away from the body of said comb,
   thereby cleaning said teeth by said perforated bar.

The method may further comprise the step of:
drawing the perforated bar (6) towards the body (8) of the comb (2),
   thereby allowing combing.

The method may further comprise the step of:
locking the perforated bar (6) near the body (8) of the comb (2).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 depicts a lice comb, according to one embodiment of the present invention.

FIG. 2 depicts the lice comb of FIG. 1, at the locked state.

FIG. 3 depicts the lice comb of FIG. 1, in the disassembled state.

FIG. 4 is a two-dimensional sectional view of the lice comb of FIG. 1.

FIG. 5 is a two-dimensional sectional view of a lice comb, according to another embodiment.

FIG. 6 is a two-dimensional sectional view of a lice comb of FIG. 5 in the cleaning state.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The terms “up”, “down”, “top” and “bottom” refer herein to the position where the teeth are up and the comb body is down, as depicted in all the figures.

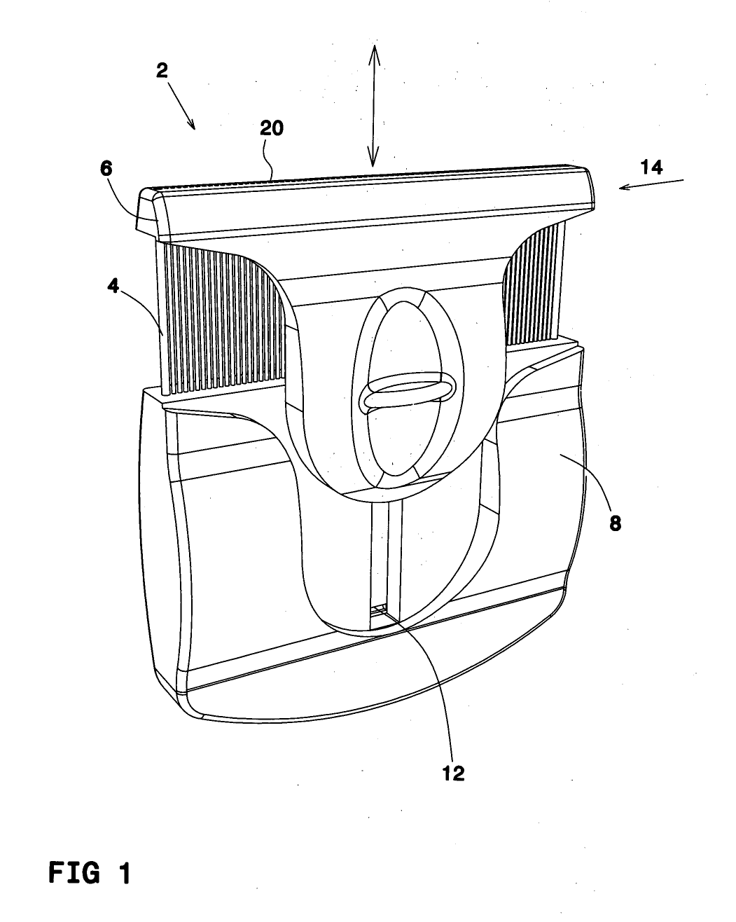

FIG. 1 depicts a lice comb, according to one embodiment of the present invention.

A lice comb 2, according to one embodiment of the present invention, includes teeth 4 extending from the body 8 of the comb, and a teeth cleaner 14. Teeth cleaner 14 may clean teeth 4 by raising and lowering thereof, i.e., by moving teeth cleaner 14 along teeth 4 away from body 8.

Each tooth 4 is inserted into a hole 20 of teeth cleaner 14, thus relative motion between hole 20 and tooth 4 cleans tooth 4. All holes 20 or at least a cluster of holes 20 of teeth cleaner 14 move altogether along teeth 4, since a perforated bar 6 binds holes 20 together.

Upon lowering teeth cleaner 14 to the lowest location, a lock 12 may lock it to a lock state.

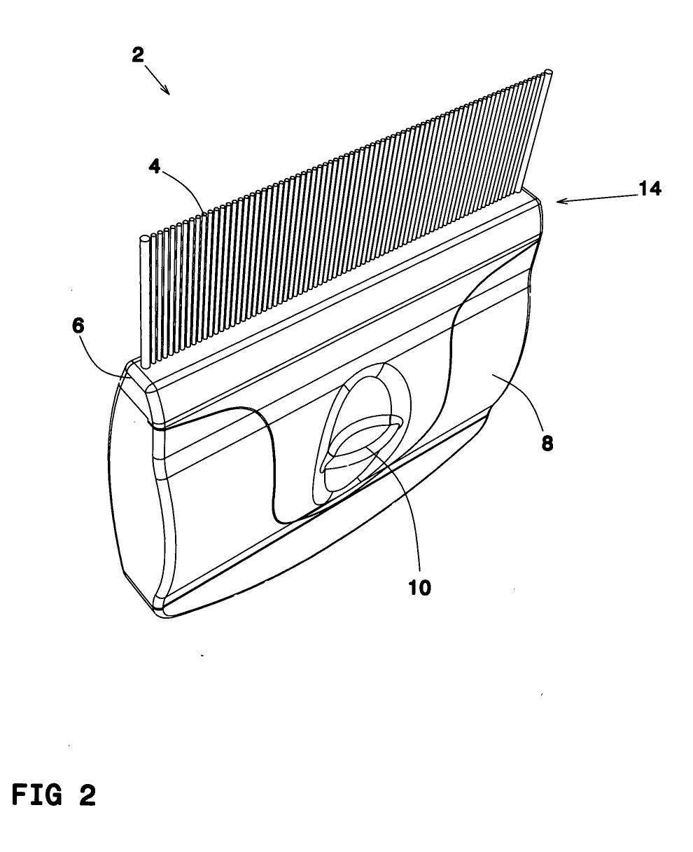

FIG. 2 depicts the lice comb of FIG. 1, in the locked state.

In the locked state, lice comb 2 functions and seems like a common lice comb. The user may comb the hair until the comb fills with lice, dirt and hair.

Instead of the prior art cleaning, a handle 10 may unlock teeth cleaner 14, for releasing thereof, and then, raising teeth cleaner 14 to the state depicted in FIG. 1 removes the lice, the dirt and the hair away from teeth 4.

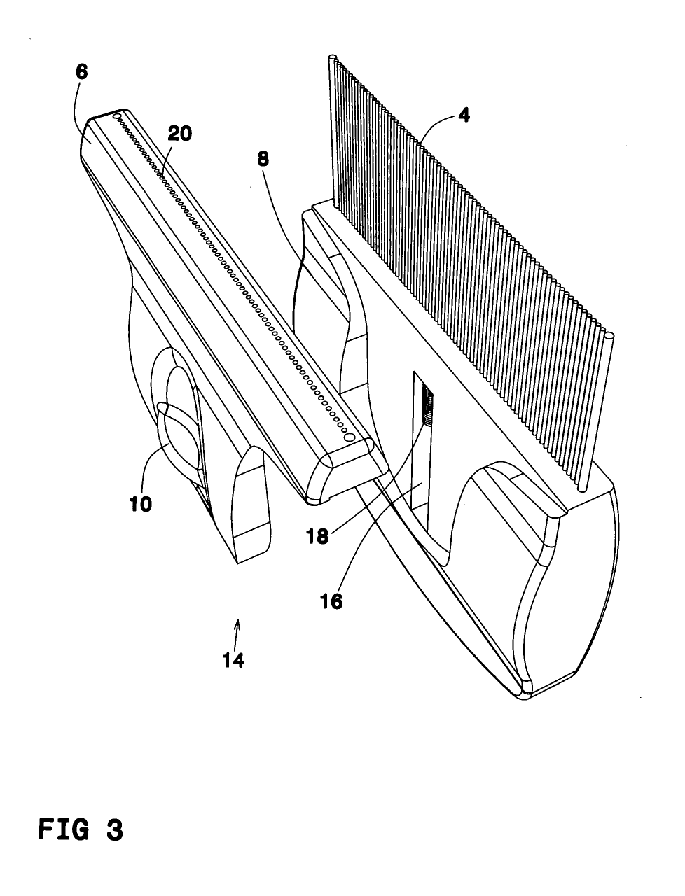

FIG. 3 depicts the lice comb of FIG. 1, in the disassembled state.

According to a preferred embodiment, a springy element 18 may normally locate holes 20 at the bottom of teeth 4, i.e., close to body 8 of comb 2, which is the position allowing combing.

Thus, cleaning teeth 4 is performed by raising teeth cleaner 14 against springy element 18. Release of teeth cleaner 14 returns teeth cleaner 14, by springy element 18, or by manual motion, to the combing state.

According to one embodiment, teeth cleaner 14 may be detached from comb-body 8 and from teeth 4. FIG. 3 depicts a track 16 in comb-body 8.

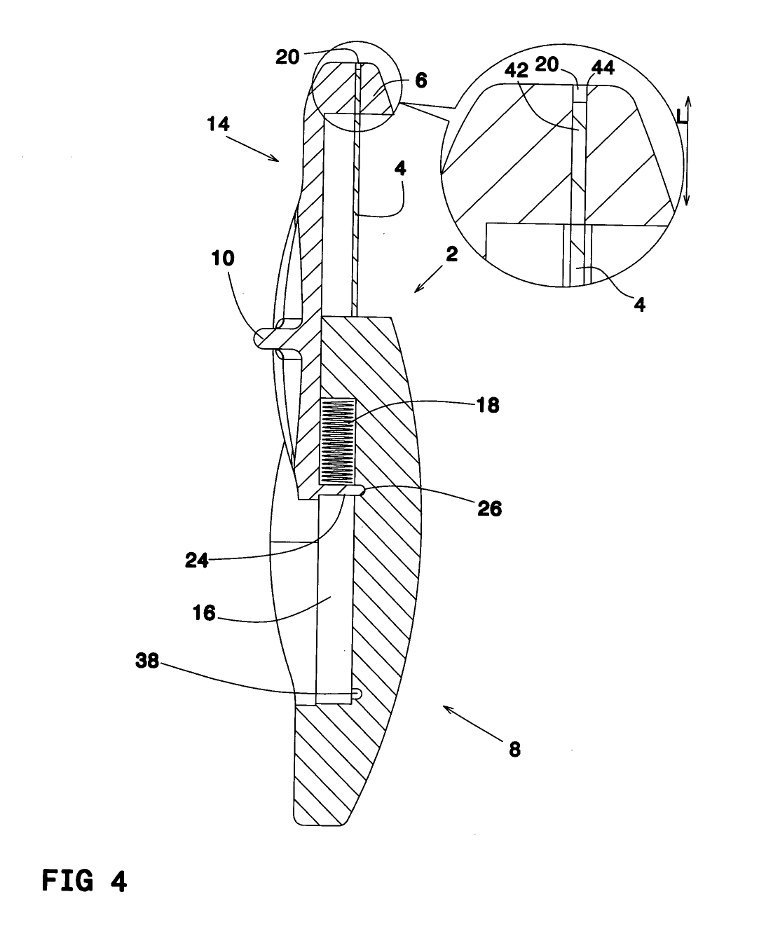

According to one embodiment, the disassembling may be done by raising a limiting element 24 (depicted in FIG. 4) against springy element 18 beyond the cleaning state depicted in FIG. 1. Thus, holes 20 are raised above the edges of teeth 4, and are no longer held by them.

Re-assembling teeth cleaner 14 is performed by inserting limiting element 24 (shown in FIG. 4) into track 16, raising it against springy element 24, and inserting teeth 24 into holes 20.

FIG. 4 is a two-dimensional sectional view of the lice comb of FIG. 1.

Teeth cleaner 14, having holes 20, may move in relation to comb-body 8 with teeth 4

Limiting element 24 of teeth cleaner 14 is movable within track 16 of comb-body 8. Limiting element 24 limits the motion of teeth cleaner 14, such that holes 20 clean most or all the length of teeth 4.

According to a preferred embodiment, each of holes 20 is elongated, for example, having length L. Limiting element 24 limits the raising of holes 20, such that the top 44 of hole 20 can reach a selected height at the top 42 of tooth 42 or even beyond, while hole 20 is yet held by tooth 4. Thus, the entire length of tooth 4 may be cleaned.

Lock 12 includes a projection 26, falling into a recess 38. Upon being pushed to the bottom projection, 26 of limiting element 24 falls into recess 38, locking teeth cleaner 14 into that position.

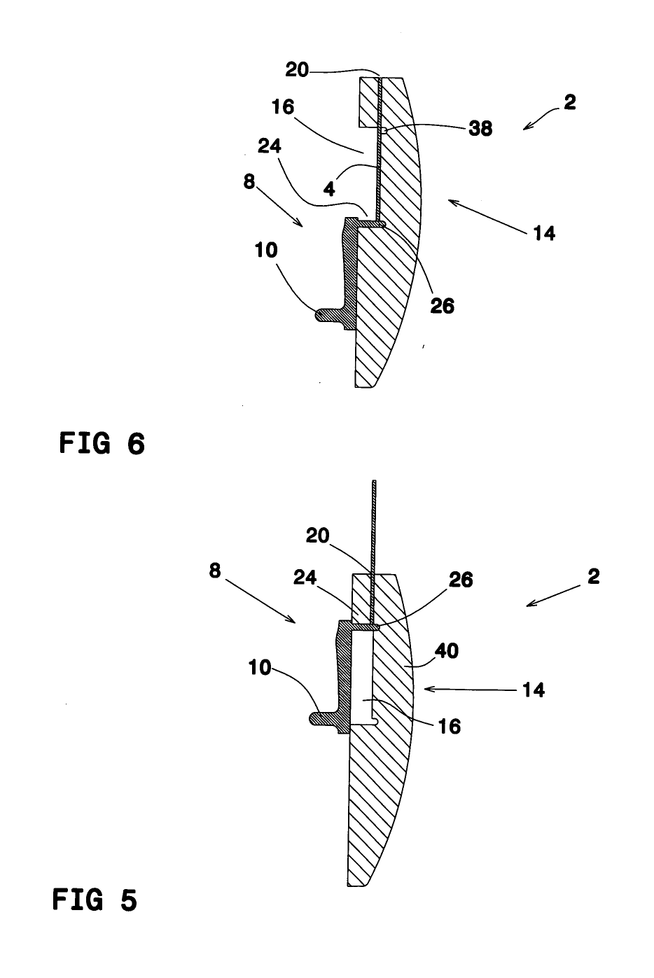

FIG. 5 is a two-dimensional sectional view of a lice comb, according to another embodiment.

Teeth cleaner 14 having holes 20 may move in relation to comb-body 8 having teeth 4. Limiting element 24 is movable within track 16 of teeth cleaner 14.

Upon pushing teeth cleaner 14 to the bottom, which is the combing state, projection 26 of limiting element 24 falls into recess 38 of teeth cleaner, locking teeth cleaner 14 and comb-body 8 into that position.

FIG. 6 is a two-dimensional sectional view of the lice comb of FIG. 5 at the cleaning state.

Teeth 4 of FIG. 5 are shown being cleaned by holes 20 of teeth cleaner 14, as teeth 4 do not outwardly extend in this state.

In the figures and/or description herein, the following reference numerals have been mentioned:
numeral 2 denotes a lice comb according to one embodiment of the present invention;
numeral 4 denotes a tooth of a lice comb;
numeral 6 denotes a perforated bar, including a cluster of holes;
numeral 8 denotes the body of the comb;
numeral 10 denotes a handle for locking and unlocking the lock;
numeral 12 denotes a lock for locking the holes of the teeth cleaner to the bottom of the teeth;
numeral 14 denotes the teeth cleaner;
numeral 16 denotes a track;
numeral 18 denotes a springy element for pushing the teeth cleaner downwards;
numeral 20 denotes a hole surrounding a tooth;
numeral 24 denotes a limiting element, for limiting the motion of the teeth cleaner;
numeral 26 denotes a projection;
numeral 38 denotes a recess;
numeral 42 denotes the top of a tooth; and
numeral 44 denotes the top of the hole.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A comb, comprising teeth extending from the body of said comb, said comb comprising:
a teeth cleaner comprising a perforated-bar in which the holes thereof surrounding said teeth,
wherein said perforated-bar and said teeth are movable one along and in relation to the other, thereby allowing removing stuck objects from said teeth.

2. A comb according to claim 1, further comprising a springy element for normally locating said perforated bar near said comb-body,
thereby by default allowing combing, and
thereby said drawing of perforated bar against said springy element cleans said teeth.

3. A comb according to claim 1, further comprising a lock,
for locking said perforated bar to attach said comb-body to allow combing, and
for unlocking said perforated bar, to allow said cleaning of said teeth.

4. A comb according to claim 1, further comprising a limiting element for limiting the motion of said perforated bar along said teeth,
thereby said perforated bar is limited to be held by said teeth.

5. A comb according to claim 1, wherein said holes of said perforated bar are elongated, for substantially reaching the top of the teeth and yet being held thereby,
thereby said perforated bar can clean the edges of said teeth.

6. A comb according to claim 1, wherein said teeth cleaner is detachable.

7. A method for cleaning teeth of a comb, the method comprising the steps of:
providing a perforated bar in which the holes thereof surrounding the teeth of said comb; and
drawing said perforated bar along said teeth away from the body of said comb,
thereby cleaning said teeth by said perforated bar.

8. A method according to claim 7, further comprising the step of:
drawing said perforated bar towards said body of said comb,
thereby allowing combing.

9. A method according to claim 8, further comprising the step of:
locking said perforated bar near said body of said comb.
